(19) United States
(12) Patent Application Publication
(10) Pub. No.: US 2025/0175031 A1
(43) Pub. Date: May 29, 2025

(54) A METHOD OF CONTROLLING A SENSOR APPARATUS FOR AN ELECTRICAL CIRCUIT

(71) Applicant: EATON INTELLIGENT POWER LIMITED, Dublin 4 (IE)

(72) Inventors: Pia DIEPMAN, Dublin (IE); James RYLE, Dublin (IE)

(21) Appl. No.: 18/730,375

(22) PCT Filed: Jan. 21, 2022
(86) PCT No.: PCT/EP2022/051405

§ 371 Date: Jul. 19, 2024

(51) Int. Cl. H02J 13/00; H02J 3/00

(52) U.S. Cl. CPC H02J 13/00002; H02J 3/001

(57) ABSTRACT

Some embodiments relate to a method of controlling a sensor apparatus for an electrical circuit. The method comprises: applying a clustering algorithm to a database of sensor measurements acquired from the sensor, the database of sensor measurements comprising sensor measurements indicative of the power supply during one or more events associated with the operation of one or more of the electrical loads and sensor measurements indicative of noise measurements during a baseline condition of the electrical circuit, the clustering algorithm being applied to the database of sensor measurements to determine a set of measurement clusters; identifying a cluster, from the set of measurement clusters, indicative of noise measurements; determining a noise threshold for the sensor based on the cluster indicative of noise measurements; and controlling one or more feedback actions of the sensor apparatus in dependence on the determined noise threshold.

### CROSS-REFERENCE TO RELATED APPLICATIONS

This application is a national phase filing under 35 C.F.R. § 371 of and claims priority to PCT Patent Application No. PCT/EP2022/051405, filed on Jan. 21, 2022, the content of which is hereby incorporated in its entirety by reference.

### TECHNICAL FIELD

The present disclosure relates generally to a method of controlling a sensor apparatus for an electrical circuit. Aspects of the disclosure relate to a method, to a sensor apparatus, and to a non-transitory, computer-readable storage medium.

### BACKGROUND

Typically, a building includes an electricity distribution apparatus, such as a panel board, configured to distribute a supply of electrical power to various electrical loads in an electrical circuit of the building. For example, the electricity distribution apparatus may include a plurality of subsidiary circuits, known as branch circuits, arranged in parallel to provide electrical connections to the electrical loads of the building. Each branch circuit may connect to one or more of the electrical loads and the electricity distribution apparatus may provide circuit breakers, or protective fuses, for controlling the power supply to each branch circuit. It is also common for the electricity distribution apparatus to include a main circuit breaker, upstream of the branch circuits, for providing absolute control over the power supply from the power line to the electrical loads.

The operation of the electrical loads creates demand for electrical power, and an electricity distribution apparatus is known that includes a sensor apparatus with one or more sensors, such as current sensors, voltage sensors, and/or temperature sensors, for monitoring the power supply to the electrical loads to inform the control of the circuit breaker mechanisms. However, a drawback of existing systems is that the sensor apparatus collects an enormous amount of data, including background signal noise or unwanted measurements, leading to costly storage and utilising significant processing resources. It is therefore desirable to improve the processing efficiency of the sensor data.

It is against this background that the disclosure has been devised.

### SUMMARY OF THE DISCLOSURE

According to an aspect of the present disclosure there is provided a method of controlling a sensor apparatus for an electrical circuit. The electrical circuit comprises one or more electrical loads and a power line providing a supply of electrical power to the one or more electrical loads. The sensor apparatus comprises a sensor configured to monitor the power line. The method comprises: applying a clustering algorithm to a database of sensor measurements acquired from the sensor, the database of sensor measurements comprising sensor measurements indicative of the power supply during one or more events associated with the operation of one or more of the electrical loads and sensor measurements indicative of noise measurements during a baseline condition of the electrical circuit (i.e. while there is substantially no power draw from the electrical loads), the clustering algorithm being applied to the database of sensor measurements to determine a set of measurement clusters; identifying a cluster, from the set of measurement clusters, indicative of noise measurements; determining a noise threshold for the sensor based on the cluster indicative of noise measurements; and controlling one or more feedback actions of the sensor apparatus in dependence on the determined noise threshold.

In this manner, the solution is advantageous in that it allows for a noise threshold to be dynamically determined, allowing noise measurements to be identified and isolated with greater accuracy compared to a static threshold. The remaining sensor measurements contain useful data relating to events associated with respective operations of the electrical loads. In this manner, the useful data can be passed on for further processing, saving the device resources. Consequently, the sensor apparatus mitigates the need for costly on-board storage resources and the determined noise threshold may be indicative of faults or changes in the condition of the electrical loads. It is anticipated that the sensor apparatus will therefore lead to a reduction in the cost of computing resources and enhanced control of the power supply to the electrical loads, facilitating additional safety measures.

Optionally, identifying the cluster indicative of noise measurements may comprise: determining a representative value for each measurement cluster; and identifying the cluster indicative of noise measurements based on a comparison of the representative values. For example, each representative value may be determined as a centroid value for the respective measurement cluster or a boundary value for the respective measurement cluster. The representative value associated with the cluster indicative of noise measurements may be less than, or greater than, the representative values associated with the other measurement clusters. It shall be appreciated that the remaining measurement clusters may be formed of sensor measurements that are indicative of events associated with respective operations of the electrical loads.

Optionally, the clustering algorithm is configured to determine the set of measurement clusters by: partitioning the database of sensor measurements into a plurality of sets of measurement clusters, each set having a different number of measurements clusters; and determining a natural number of measurement clusters for the database of sensor measurements. For example, the database of sensor measurements may be partitioned into multiple sets of measurement clusters using one or more prescribed partitioning parameters.

Optionally, the natural number of measurement clusters is determined based on an explained variance determined for each set of measurement clusters. For example, the natural number of measurement clusters may be determined according to an elbow method. It shall be appreciated that the elbow method of determining the natural number of clusters in a dataset is well known in the art of data processing.

Optionally, the clustering algorithm is configured to validate the determined set of measurement clusters by: determining a silhouette value for the set of measurement clusters; and comparing the determined silhouette value to a threshold value. For example, a threshold value of 0.7 provides adequate clustering accuracy for identifying the cluster indicative of noise measurements.

In an example, the clustering algorithm is configured to redetermine the set of measurement clusters (e.g. using different partitioning parameters) if the silhouette value is less than the threshold value.

The noise threshold for the sensor may, for example, be determined as a centroid value, or a boundary value, of the cluster indicative of noise measurements.

Optionally, the method further comprises: acquiring one or more further sensor measurements from the sensor; and updating the database of sensor measurements to include the one or more further sensor measurements. Optionally, the method further comprises updating the noise threshold based on the updated database of sensor measurements. In this manner, the noise threshold may be dynamically updated based on recent sensor measurements and changes in the noise threshold (which may be indicative of faults in the electrical circuit) can be identified.

The one or more feedback actions may, for example, include: transmitting, via a communications module of the sensor apparatus, a warning signal to the one or more electrical loads and/or to an external server in dependence on the determined noise threshold; filtering noise measurements from the database of sensor measurements by applying the noise threshold; and/or selectively interrupting, via a circuit breaker mechanism of the sensor apparatus, the power supply to the one or more electrical loads.

Optionally, the sensor apparatus includes N sensors for monitoring the power line, where Nis a positive integer, and wherein the database of sensor measurements is a database of N-dimensional data points, each data point comprising sensor measurements acquired from the N sensors at a respective time. A respective noise threshold may therefore be determined for each of the N sensors based on the respective sensor measurements acquired from that sensor in the cluster indicative of noise measurements. In this manner, the sensor apparatus may be operated to determine respective noise thresholds for each of the sensors onboard the sensor apparatus using the same method. For example, the N sensors may include a current sensor, a voltage sensor, and/or a temperature sensor and a respective threshold may be determined for each sensor based on respective sensor measurements in the cluster indicative of noise measurements.

Optionally, the method further comprises detecting an event associated with the operation of one or more of the electrical loads by: acquiring an electrical power signal composed of a series of sensor measurements obtained by the sensor during the event; determining a power spectral density of the electrical power signal; and detecting the event by comparing the determined power spectral density to a reference power spectral density for the power line. In this manner, the method may make use of the filtered dataset, or useful data, to infer information concerning the operation of the electrical loads. In particular, the electrical power signal fluctuates due to the transient processes of the electrical loads, which generates characteristic signal noise spectra. The method advantageously detects such changes in the power spectral density of the electrical power signal and thereby detects respective events associated with the operation of the electrical loads.

The reference power spectral density for the power line may, for example, be associated with at least one of: a previous event; a baseline condition of the power line, with substantially no power being drawn by the one or more electrical loads; and/or an average condition of the power line. In other words, the reference power spectral density may be based on a respective electrical power signal composed of a series of sensor measurements acquired for a previous event associated with the operations of the electrical loads, the baseline condition, or the average condition of the electrical circuit.

For example, the event may be detected by: determining a first curve function representing the power spectral density of the electrical power signal; determining a second curve function representing the reference power spectral density; and detecting the event based on a deviation of the first curve function from the second curve function. For example, the first and second curve functions may be determined using one or more curve fitting functions. For example, the first curve function may represent an average power curve or a floor of the determined PSD. The second curve function may similarly represent an average power curve or a floor of the reference PSD. It shall be appreciated that each of the first and second curve functions may therefore include a 1/f\hat{ }β curve function for a relatively low frequency range (where β may be a positive integer), and a further function for broadband noise at a higher frequency range.

Optionally, the method further comprises: determining one or more transformation operations from the second curve function to the first curve function; and classifying the event based on the determined one or more transformation operations. For example, such classification may be made with reference to a look-up table, or an events database, of predetermined events and respective transformation operations. It shall be appreciated that the circuit breaker is configured to classify the event in the sense of either matching the event to a predetermined event in the events database or otherwise identifying the event as an unclassified event. In this manner, the characteristic signal noise introduced by a transient operation of one or more of the electrical loads can be identified and classified.

The method may further comprise controlling one or more feedback actions of the sensor apparatus in dependence on the event classification, the one or more feedback actions including: transmitting, via a communications module of the sensor apparatus, a warning signal to the one or more electrical loads and/or to an external server; and/or selectively interrupting, via a circuit breaker mechanism of the sensor apparatus, the power supply to the one or more electrical loads.

The method may be executed by a computer processor of the sensor apparatus, for example. In this manner, the sensor apparatus may provide for effective data processing in a device connected to the electrical circuit. Optionally, the sensor apparatus comprises the database of sensor measurements.

According to another aspect of the disclosure there is provided a non-transitory, computer-readable storage medium having instructions stored thereon that, when executed by a computer processor, cause the computer processor to carry out the method as described in a previous aspect of the disclosure.

According to a further aspect of the disclosure there is provided a sensor apparatus for an electrical circuit, the electrical circuit comprising one or more electrical loads and a power line providing a supply of electrical power to the one or more electrical loads, the sensor apparatus comprising: a sensor configured to monitor the power line; and a control module configured to execute the method as described in a previous aspect of the disclosure; wherein the sensor is configured to acquire the database of sensor measurements.

Optionally, the sensor apparatus further comprises a circuit breaker mechanism, and wherein the one or more feedback actions of the sensor apparatus comprise controlling the circuit breaker mechanism to selectively interrupt the power supply to the one or more electrical loads. For example, the sensor apparatus may be embodied as an energy management circuit breaker.

According to yet another aspect of the disclosure there is provided a method of controlling a sensor apparatus for an electrical circuit. The electrical circuit comprises one or more electrical loads and a power line providing a supply of electrical power to the one or more electrical loads. The sensor apparatus comprises a sensor configured to monitor the power line. The method comprises: acquiring an electrical power signal composed of a series of sensor measurements obtained by the sensor for a respective event; determining a power spectral density of the electrical power signal; detecting the event by comparing the determined power spectral density to a reference power spectral density for the power line, the comparison comprising: determining a first curve function representing the power spectral density of the electrical power signal; determining a second curve function representing the reference power spectral density; and detecting the event based on a deviation of the first curve function from the second curve function.

For example, the reference power spectral density for the power line may be associated with at least one of: a previous event; a baseline condition of the power line, with substantially no power being drawn by the one or more electrical loads; and/or an average condition of the power line.

Optionally, the method further comprises: determining one or more transformation operations from the second curve function to the first curve function; and classifying the event based on the determined one or more transformation operations.

Optionally, the method further comprises controlling one or more feedback actions of the sensor apparatus in dependence on the detected event, the one or more feedback actions including: transmitting, via a communications module of the sensor apparatus, a warning signal to the one or more electrical loads and/or to an external server in dependence on the detected event; and/or selectively interrupting, via a circuit breaker mechanism of the sensor apparatus, the power supply to the one or more electrical loads.

According to another aspect of the disclosure, there is provided an electrical distribution apparatus for connection to a power line supplying electrical power to one or more electrical loads in a building, the electrical distribution apparatus comprising a sensor apparatus breaker as described in a previous aspect.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 shows a simplified schematic view of an electrical circuit that is formed by an electricity distribution apparatus used to distribute a supply of electrical power to a plurality of electrical loads in a building;

FIG. 2 shows a schematic view of an exemplary sensor apparatus of the electricity distribution apparatus shown in FIG. 1;

FIG. 3 shows the steps of an example method of controlling the sensor apparatus shown in FIG. 2;

FIG. 4 shows exemplary sub-steps of the method shown in FIG. 3;

FIG. 5 shows further exemplary sub-steps of the method shown in FIG. 3;

FIG. 6 shows an example set of measurement clusters determined according to the method shown in FIG. 3;

FIG. 7 shows a schematic view of another exemplary sensor apparatus of the electricity distribution apparatus shown in FIG. 1;

FIG. 8 shows the steps of an example method of controlling the sensor apparatus shown in FIG. 7; and

FIG. 9 shows exemplary sub-steps of the method shown in FIG. 8.

### DETAILED DESCRIPTION

Embodiments of the disclosure relate to a sensor apparatus for an electrical circuit, and to a method of controlling the sensor apparatus. The electrical circuit comprises one or more electrical loads and a power line providing a supply of electrical power to the one or more electrical loads. The sensor apparatus includes one or more sensors configured to monitor the power line, for example to detect various events associated with respective operations of the connected electrical loads. One or more feedback actions may subsequently be enacted based on the acquired sensor measurements. For example, upon detecting a fault or a change in operation of one of the electrical loads, the sensor apparatus may operate a circuit breaker mechanism of the sensor apparatus to interrupt the power supply and thereby protect the electrical loads from a current surge.

For this purpose, a database of sensor measurements is acquired by the sensor apparatus and a noise threshold is determined for each sensor, where the noise threshold(s) may be used to filter noise from the database. The remaining sensor measurements are then retained, which contain useful data relating to events associated with respective operations of the electrical loads. For example, the database of sensor measurements acquired by the sensor(s) will include sensor measurements that are indicative of the power supply during one or more events associated with respective operations of the electrical loads, as well as sensor measurements that are indicative of noise measurements acquired during a baseline condition of the electrical circuit. In this context, a baseline condition is a condition with substantially no power draw by the one or more electrical loads, such that respective sensor measurements acquired during the baseline condition are indicative of background signal noise. Accordingly, to identify and isolate the noise measurements, the sensor apparatus is advantageously configured to: apply a clustering algorithm to the database of sensor measurements to determine a set of measurement clusters; identify a cluster, from the set of measurement clusters, as being indicative of noise measurements; and determine a noise threshold for each sensor based on the cluster indicative of noise measurements.

The noise threshold can then be applied to filter the acquired sensor measurements, isolating the noise from useful measurements relating to operations of the electrical appliances and allowing computationally intensive processes to be executed on a refined dataset. Changes in the noise threshold(s) may also be indicative of faults or respective changes in the condition of the electrical loads.

For example, the sensor apparatus may use the filtered data to detect events associated with the operation of the connected electrical loads and identify faults thereof. In particular, the filtered data may be used to determine the power spectral density of the power supply during an event and to identify deviations in that power spectrum, relative to a reference condition, as may be caused by transient operations of the electrical loads. For example, heating elements are predominantly resistive in nature and will produce a white noise spectrum associated with their operation. Inductive motors on the other hand will have resistive and inductive loads, with arcing occurring at the stator contact points leading to an increase in pink noise. Hence, potential faults, such as arcing, are identifiable by the associated pink noise spectrum that is introduced into the determined power spectrum.

In this manner, the sensor apparatus is operable to detect events associated with respective operations of the connected electrical loads and to execute one or more feedback actions, such as interrupting the power supply, via a circuit breaker mechanism of the sensor apparatus, or issuing power warnings, via a communications module of the sensor apparatus.

It is anticipated that the sensor apparatus will therefore lead to a reduction in the cost of computing resources and enhanced control of the power supply to the electrical loads, facilitating additional safety measures.

The sensor apparatus shall now be discussed in more detail with reference to an example application in a simple exemplary electrical circuit.

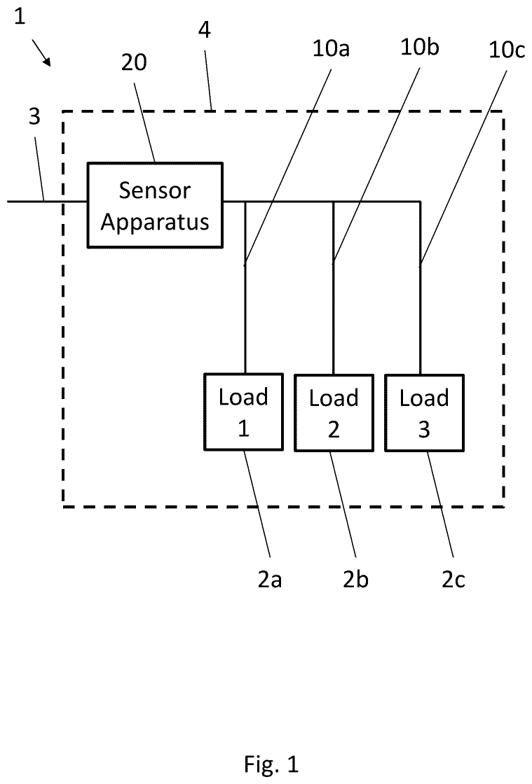

FIG. 1 schematically illustrates an example electrical circuit 1 for supplying electrical power to a plurality of electrical loads 2a-c of a building. The electrical circuit 1 features a power line 3 and an electrical distribution apparatus 4, through which the power line 3 is connected to the plurality of electrical loads 2a-c.

The power line 3 provides an electrical power supply to the electrical loads 2a-c of the building and may, for example, take the form of a supply line from a power distribution network or power grid.

The electricity distribution apparatus 4 is configured to distribute the electrical power supply to the electrical loads 2a-c and may, for example, take the form of a panel board. The electricity distribution apparatus 4 comprises a plurality of branch circuits 10a-c, arranged in parallel, that connect to the electrical loads 2a-c of the building. For the sake of simplicity, the plurality of branch circuits 10a-c includes a first branch circuit 10a, a second branch circuit 10b, and a third branch circuit 10c, in this example. Furthermore, each branch circuit 10a-c connects to a respective electrical load 2a-c of the building, in this example, as may be formed by a respective electrical appliance.

It shall be appreciated that the example electricity distribution apparatus 4 is not intended to be limiting on the scope of the disclosure though and, in other examples, the electricity distribution apparatus 4 may include any number of branch circuits and each branch circuit may connect to one or more electrical loads formed by respective electrical appliances, for example.

The electricity distribution apparatus 4 is shown to include a sensor apparatus 20 for monitoring the power supply to the electrical loads 2a-c connected to the power line 3. The sensor apparatus 20 may, for example, take the form of an energy management circuit breaker that further includes a circuit breaker mechanism for selectively interrupting the power supply to the electrical loads 2a-c. In this example, the sensor apparatus 20 is connected to the power line 3, upstream of the branch circuits 10a-c, where the circuit breaker mechanism can act as a main circuit breaker for providing absolute control of the electrical power supply to the electrical loads 2a-c.

However, in other examples, it shall be appreciated that the electrical distribution apparatus 4 may additionally, or alternatively, include one or more sensor apparatuses arranged in respective branch circuits 10a-c of the electricity distribution apparatus 4. Such sensor apparatuses may be substantially identical to the described sensor apparatuses 20, arranged in respective branch circuits 10a-c for monitoring and/or controlling the power supply therethrough to the respective electrical loads 2a-c.

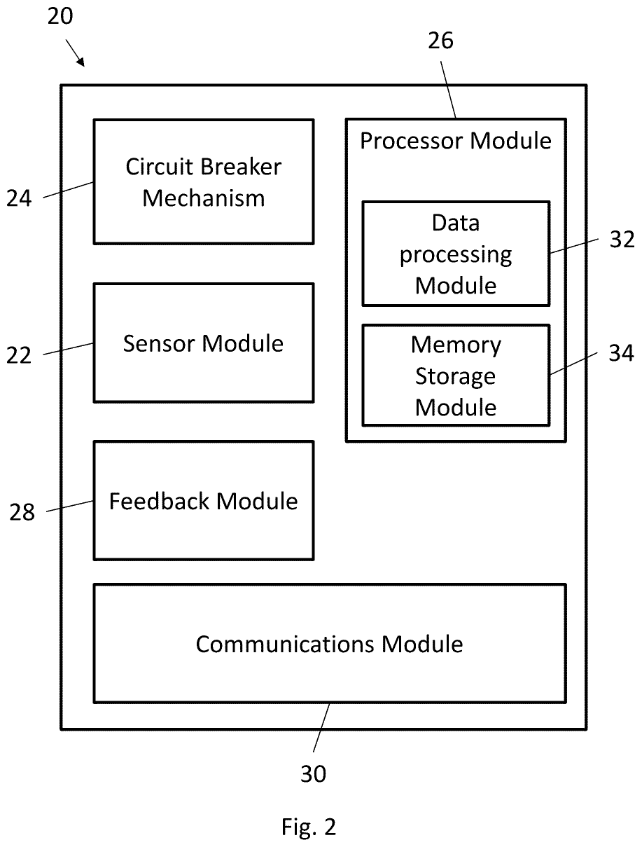

The sensor apparatus 20 shall now be considered in more detail with reference to FIG. 2, which illustrates a non-limiting example of the sensor apparatus 20.

As shown in FIG. 2, the sensor apparatus 20 may include a sensor module 22, a circuit breaker mechanism 24, a processor module 26, a feedback module 28 and a communications module 30.

That is, in the described example five functional elements, units or modules are shown. Each of these units or modules may be provided, at least in part, by suitable software running on any suitable computing substrate using conventional or customer processors and memory. Some or all of the units or modules may use a common computing substrate (for example, they may run on the same server) or separate substrates, or different combinations of the modules may be distributed between multiple computing devices.

The sensor module 22 is configured to acquire sensor measurements indicative of the power supply to the electrical loads 2a-c. For this purpose, the sensor module 22 may comprise, or connect to, one or more sensors (not shown) configured to measure the current, the temperature, and/or the voltage, of the power supply. For example, the sensor module 22 may connect to any positive integer, N, of sensors. The N sensors may include a temperature sensor for measuring the temperature of the power supply, a current sensor for measuring the current of the power supply, and/or a voltage sensor for measuring the voltage of the power supply. The temperature sensor, the current sensor, and the voltage sensor, may connect to the power line 3 upstream of the branch circuits 10a-c to allow sampling of the power supply to each of the electrical loads 2a-c simultaneously. However, in other examples, sensors may be arranged in each of the branch circuits 10a-c to allow sampling of the power supply to the electrical loads 2a-c individually.

The circuit breaker mechanism 24 is operable to selectively interrupt the power supply to the electrical loads 2a-c based on the acquired sensor measurements. For example, the circuit breaker mechanism 24 may be operated to interrupt the power supply in response to detecting sensor measurements that are indicative of a change in the noise threshold(s) of the sensor module 22. Accordingly, the circuit breaker mechanism 24 may include a mechanical or electrical switch (not shown) for interrupting the electrical power supply and a controller (not shown) for operating the switch.

The processor module 26 is configured to perform various data processing tasks associated with the sensor measurements acquired by the sensor module 22, including determining noise thresholds for the respective N sensors of the sensor module 22. In order to determine the noise threshold(s), the processor module 26 may include a data processing module 32, and a memory storage module 34, as shown in FIG. 2.

The memory storage module 34 comprises a database of sensor measurements acquired from the sensor module 22, including sensor measurements indicative of the power supply during one or more events associated with the operation of the electrical loads 2a-c and sensor measurements indicative of noise measurements during a baseline condition of the electrical circuit 1 (during which there is negligible or substantially no power draw from the electrical loads 2a-c). The sensor measurements determined by the sensor module 22 may be added to the database continuously, or periodically, to establish, or update, the database. In particular, the database of sensor measurements may be updated or established upon receiving further sensor measurements from the sensor module, and/or upon activating any one or more of the N sensors.

It shall be appreciated that the database of sensor measurements may therefore take the form of a database of N-dimensional data points, where each data point comprises a set of N sensor measurements acquired from the N sensors at a respective time. The data points may be pre-processed prior to addition to the database, for example such that the measurements are reduced to critical components, such as current/voltage/temperature readings, timestamps and device identification numbers.

The memory storage module 34 may interact with the communications module 30 of the sensor apparatus 20, which may connect to one or more external servers for providing updates, corrections, or additions to the memory storage module 34.

For the purpose of receiving and/or storing such data, the memory storage module 34 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The data processing module 32 is configured to analyse the database of sensor measurements to determine a noise threshold for each of the N sensors of the sensor module 22. For this purpose, the data processing module 32 includes one or more clustering algorithms for partitioning the database of sensor measurements into a set of measurements clusters, from which a cluster indicative of noise measurements can be identified (i.e. a noise measurement cluster). The noise measurement cluster includes data points (i.e. respective sensor measurements) corresponding to a baseline condition of the electrical circuit 1, during which the power draw of the electrical loads 2a-c is substantially zero. The remaining measurement clusters may each represent clusters of data points (or sensor measurements) associated with respective events, i.e. associated with particular operations of the electrical loads 2a-c. For example, each of the remaining measurement clusters, i.e. the regular measurement clusters, may comprise sensor measurements for each of the N sensors acquired during a particular operation of one or more of the electrical loads 2a-c. For example, the regular measurement clusters may include respective measurements clusters comprising sensor measurements associated with the activation/deactivation of each of the electrical loads 2a-c.

The data processing module 32 is further configured to determine the noise threshold for each sensor of the sensor module 22 based on the noise measurement cluster. For example, the data processing module 32 may determine a threshold current, voltage, or temperature, value for the respective N sensors of the sensor module 22 based on the respective sensor measurements in the noise measurement cluster. The noise thresholds may subsequently be used to isolate or filter the noise measurements, or a noise component, from the acquired sensor measurements.

Determining the noise threshold(s) in this manner therefore requires suitable partitioning of the database of sensor measurements into an accurate set of measurement clusters. In this context, the accuracy of each measurement cluster is a measure of the cohesion of its constituent data points, or sensor measurements, to the respective measurement cluster when compared to other measurement clusters. It shall be appreciated that there is therefore a trade-off as the number of measurement clusters increases, which produces greater cohesion of the sensor measurements to the respective measurement clusters but reduced separation from other measurement clusters.

Accordingly, in order to determine an accurate set of measurement clusters, the data processing module 32 may include one or more clustering algorithms configured to partition the database of sensor measurements into a plurality of sets of measurements clusters, and to identify the set of measurements clusters that best represents the natural clusters within the database of sensor measurements, i.e. having an optimal number of measurement clusters. For this purpose, the data processing module 32 may use one or more partitioning parameters for determining how the database of sensor measurements may be partitioned into the plurality of sets of measurement clusters. Such partitioning parameters may be stored as predefined variables or instructions in the processing module 32 or the memory storage module 34, for example.

To give an example, the clustering algorithm may be configured to determine the optimal number of measurements clusters from the plurality of sets of measurements clusters using an elbow method. According to the elbow method, the clustering algorithm partitions the database of sensor measurements into multiple sets of measurement clusters, each set having a different number of measurements clusters, and the optimal number of measurement clusters is identified as an elbow point of the explained variance for each set of measurement clusters as a function of the number of measurements clusters. In this context, the explained variance uses a ratio of between-group variance of the data points, or sensor measurements, of each measurement clusters to the total variance, where variance is a measure, such as a distance measure, of dispersion from a centroid of the measurement cluster.

The data processing module 32 may be further configured to assess the accuracy of the set of measurement clusters having the optimal number of clusters using an accuracy threshold. For example, the data processing module 32 may be configured to determine a silhouette value for the identified set of measurement clusters, and to use a silhouette threshold value of greater than or equal to 0.7, which is generally understood in the art to validate clustering accuracy. If the determined silhouette value is less than the threshold value, the data processing module 32 may be configured to redetermine the set of measurement clusters, for example using different partitioning parameters, as may be stored or otherwise prescribed by one or more rules or instructions of the data processing module 32.

Once a suitable set of measurement clusters has been determined, the data processing module 32 is further configured to identify the cluster, from amongst the determined set of measurement clusters, that is indicative of noise measurements, i.e. the noise measurement cluster. For example, the data processing module 32 may be configured to identify the noise measurement cluster by comparing centroid, or boundary values, of each measurement cluster to one another and thereby identifying the noise measurement cluster, for example as an irregular measurement cluster, that is distinguished from the other measurement clusters. For example, taking the sensor measurements acquired by the current sensor as an example, the centroid value of the noise measurement cluster may have an irregular centroid value that may be lower, or significantly lower, than the centroid values of the other measurement clusters, i.e. the regular measurement clusters.

Once the noise measurement cluster has been identified, the data processing module 32 may be further configured to set a respective noise threshold for each sensor of the sensor module 22 based on the data points, or sensor measurements, in the noise measurement cluster. For this purpose, the data processing module 32 may also include one or more algorithms, schemes, or rules. In an example, the noise threshold for each of the current, voltage, and/or temperature, sensors may be set as a centroid value, or a boundary value (i.e. an upper limit value or a lower limit value), of the respective sensor measurements in the cluster of noise measurements, for example.

The feedback module 28 is configured to control one or more feedback actions in dependence on the determined noise threshold(s). In particular, the processor module 26 may redetermine the noise threshold periodically, and/or upon start-up of the sensors of the circuit breaker 20. Upon determining a new noise threshold, the feedback module 28 may be configured to update the noise threshold(s) associated with one or more of the sensors of the sensor module 22. The feedback module 28 may additionally, or alternatively, be configured to filter the database of sensor measurements according to the noise threshold(s), and/or to communicate the updated noise threshold(s) to an external server, a user smartphone, or a technician via the communications module 30. To give an example, an updated noise threshold may be communicated to a user, as a warning system indicative of a fault in one or more of the electrical loads, for example.

The feedback module 28 may also be configured to send a control signal to operate the circuit breaker mechanism 24 to interrupt the power supply to the electrical devices 2a-c, and/or to send a control signal to one or more of the electrical loads 2a-c (for example to suspend an operation of the electrical device).

The communications module 30 is configured to connect to one or more external servers, and/or the electrical loads 2a-c, for example to execute the feedback actions and/or to update the database of sensor measurements. For this purpose, the communications module 30 may, for example, include a wireless communication module configured to form a wireless connection to an external server or wireless network. The communications module 30 may therefore facilitate the offline analysis of noise thresholds and provide a means for updating the database of sensor measurements.

For the purposes of this disclosure, it is to be understood that the functional elements, units and modules described herein may each comprise a control unit or computational device having one or more electronic processors. A set of instructions could be provided which, when executed, cause said control unit(s) to implement the control techniques described herein (including the described method(s)). The set of instructions may be embedded in one or more electronic processors, or alternatively, the set of instructions could be provided as software to be executed by one or more electronic processor(s). The set of instructions may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

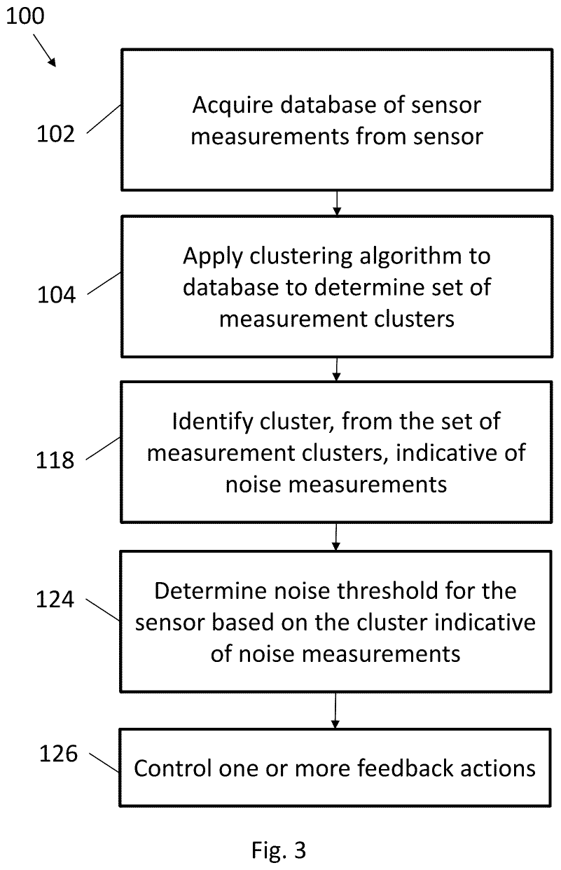

The operation of the sensor apparatus 20 in the example electrical circuit 1 shall now be described with additional reference to FIGS. 3 to 6.

FIG. 3 shows an example method 100 of controlling the sensor apparatus 20, in accordance with an embodiment of the disclosure.

In step 102, the sensor apparatus 20 is configured to acquire a database of sensor measurements from the sensor module 22 including: (i) a plurality of sensor measurements indicative of the power supply during one or more events associated with the operation of the electrical loads 2a-c, and (ii) a plurality of sensor measurements indicative of noise measurements during a baseline condition of the electrical circuit 1.

For example, the sensor module 22 may operate the current sensor, the voltage sensor, and/or the temperature sensor, to monitor the power supply to the electrical loads 2a-c and to determine respective sensor measurements, which may be communicated to the memory storage module 34 to update, or otherwise to establish, the database of sensor measurements. Alternatively, the circuit breaker 20 may acquire the database of sensor measurements from the memory storage module 34, where such sensor measurements are historic sensor measurements determined by the sensor module 22 previously.

As the sensor module 22, includes N sensors, in this example, the acquired database of sensor measurements may therefore take the form of a database of N-dimensional data points, each data point comprising respective sensor measurements acquired from the N sensors at a respective time. In this manner, the data points may include pre-processed sensor measurements, from which non-critical components have been removed to retain respective current/voltage/temperature readings, timestamps and device identification numbers, for example.

In step 104, the sensor apparatus 20 is configured to apply the clustering algorithm to the database of sensor measurements to determine a set of measurement clusters.

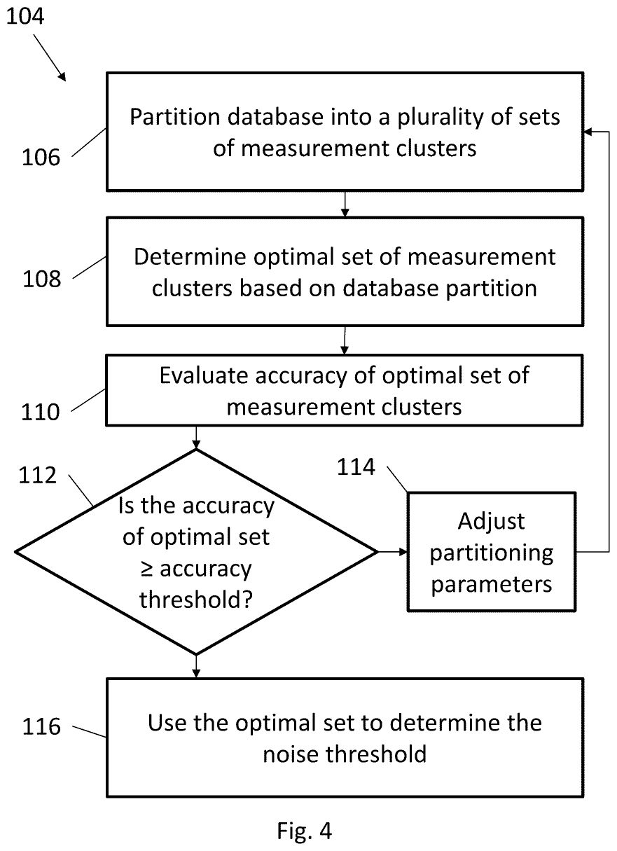

It shall be appreciated that the set of measurement clusters may be determined by applying one or more clustering algorithms that are known in the art, where one such example is described below with reference to FIG. 4.

FIG. 4 shows example sub-steps 106 to 116 of the method 100 for determining the set of measurement clusters, in accordance with an embodiment of the disclosure.

In this example, the clustering algorithm is configured to determine the set of measurement clusters in a three-stage process that includes: (i) partitioning the database of sensor measurements into a plurality of sets of measurements clusters, (ii) identifying the set of measurements clusters that best represents the natural clusters within the database of sensor measurements, and (iii) assessing the accuracy of the identified set of measurement clusters.

In particular, in sub-step 106, the data processing module 32 may apply the clustering algorithm to partition the database of sensor measurement into multiple sets of measurement clusters, each having a different number of measurement clusters. For example, one or more partitioning parameters of the clustering algorithm may determine the number of sets of measurement clusters to determine and, for each set of measurement clusters, a quantity of measurement clusters that the database of sensor measurements should be partitioned into.

In sub-step 108, the clustering algorithm further identifies the optimal set of measurement clusters from the plurality of sets determined in sub-step 106. In this example, the clustering algorithm is configured to identify the optimal set by determining the natural number of measurements clusters from the plurality of sets of measurements clusters using an elbow method. In particular, the clustering algorithm is configured to determine and compare values of explained variance for each set, as a function of the number of measurements clusters, and to determine an elbow point of the function. The elbow point of the function provides the natural number of measurements clusters for the respective partitioning parameters. Accordingly, the optimal set of measurement clusters is identified as the respective set of measurement clusters having the natural number of measurement clusters.

In sub-step 110, the accuracy of the clustering is evaluated against an accuracy threshold. For this purpose, the clustering algorithm may include one or more rules, methods, or schemes, that are known in the art for assessing the accuracy of the identified set of measurement clusters.

To give one advantageous example, the clustering algorithm may be configured to assess the accuracy of the clustering by determining a silhouette, i.e. a silhouette value, for the optimal set of measurement clusters. The silhouette value is a measure of how similar the data points (i.e. the sensor measurements from the N sensors) are to their respective measurement clusters compared to other measurements clusters, and ranges from values of −1 to +1. A high value indicates that the data points, or sensor measurements, are well matched to the respective measurement cluster and poorly matched to neighbouring measurement clusters. A low, or negative, silhouette value indicates that the clustering configuration may have too many or too few clusters. As shall be appreciated by the skilled person, the silhouette can be calculated with any distance metric, such as the Euclidean distance or the Manhattan distance, for example.

In sub-step 112, the determined clustering accuracy is compared to an accuracy threshold. For example, the determined silhouette value may be compared to a threshold silhouette value.

For the purposes of this presently disclosed subject matter, a silhouette threshold of 0.7 is considered to confer sufficient clustering accuracy, as is consistent with generally accepted standards in the art.

If the determined accuracy is less than the threshold value, the clustering algorithm may be configured to redetermine the set of measurement clusters, according to sub-steps 104 to 110. For this purpose, the clustering algorithm may be configured to adjust the partitioning parameters, in sub-step 114, for example according to a predetermined rule or scheme of the processing module 32.

Once the determined accuracy exceeds the threshold value, e.g. once a silhouette value of greater than, or equal to, 0.7 is determined, the optimal set of measurement clusters may be approved for thresholding, in sub-step 116.

Accordingly, returning to FIG. 3, the method 100 may proceed to identify the cluster, from the set of measurement clusters, that is indicative of noise measurements, i.e. to identify the noise measurement cluster, in step 118.

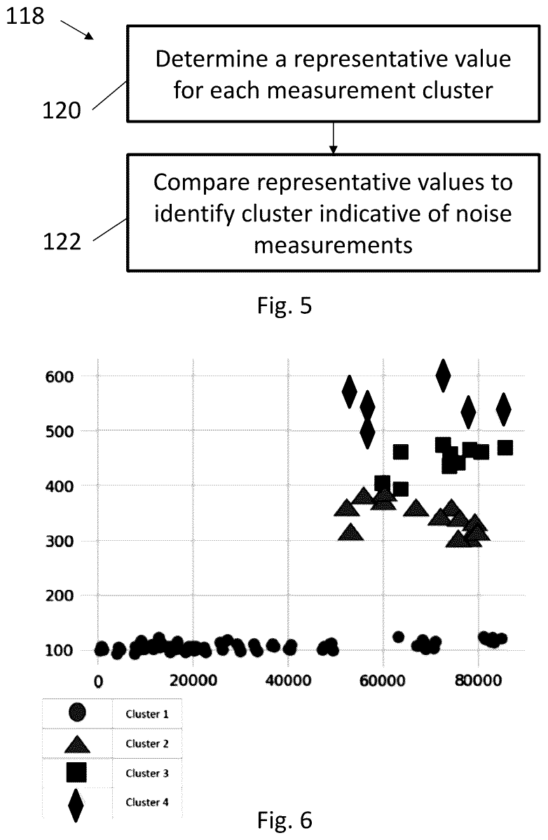

The sensor apparatus 20 may be configured to use one or more methods, schemes, or rules, that are known in the art for identifying the noise measurement cluster from the set of measurement clusters. For the sake of clarity, an advantageous example is described below with reference to FIGS. 5 and 6.

FIG. 5 shows example sub-steps 120 and 122 of the method 100 for identifying the noise measurement cluster from the set of measurement clusters, in accordance with an embodiment of the disclosure.

In sub-step 120, the data processing module 32 determines a representative value for each measurement cluster and, in sub-step 122, the data processing module 32 compares the representative values to identify the noise measurement cluster, for example as an irregular measurement cluster. For example, the data processing module 32 may determine a centroid value for each measurement cluster, such as an average current value for each measurement cluster, and identify the noise measurement cluster as an irregular measurement cluster based on the centroid values. For example, the centroid value of the noise measurement cluster may typically be identified as a maximum or a minimum centroid value of the set of measurement clusters.

To illustrate this, FIG. 6 shows an example set of measurement clusters, as determined in step 104, where the sensor measurements acquired by the current sensor are shown as belonging to a respective measurement cluster, or ‘Cluster group’, by respective markers, as indicated in the key.

FIG. 6 illustrates the sensor measurements on a graph depicting current values on the Y-axis and time on the X-axis. In this example, ‘Cluster group 1’ is identifiable as the noise measurement cluster, as the sensor measurement represented by the circular markers are grouped together at significantly lower current values than the other measurement clusters. Accordingly, by determining centroid values for each measurement cluster and comparing such values, according to sub-steps 120 and 122, ‘Cluster group 1’ would be identified as the noise measurement cluster, having the lowest centroid value. The data points of ‘Cluster group 1’ are therefore considered to represent sensor measurements indicative of the noise in the electrical circuit 1. The remaining, regular, measurement clusters, i.e. Cluster groups 2 to 4, may be considered to represent data points or sensor measurements determined by the N sensors during respective events, for example, where Cluster group 2 may represent the activation of the first electrical load 2a and Cluster group 4 may represent the activation of the first and third electrical loads 2a, 2c.

In other examples, it shall be appreciated that the data processing module 32 may identify the noise measurement cluster according to one or more alternative algorithms, rules, or methods. For example, the data processing module 32 may instead be configured to determine a boundary value, such as a maximum or minimum value of each measurement cluster, and to compare the boundary values of the measurement clusters to identify the noise measurement cluster.

Returning to FIG. 3, in step 124, the data processing module 32 proceeds to determine the noise threshold for each sensor of the sensor module 22 based on the identified noise measurement cluster. For example, the data processing module 32 may determine a respective noise threshold for each of the N sensors, including the current sensor, the voltage sensor, and/or the temperature sensor, based on respective sensor measurements in the data points of the noise measurement cluster.

The data processing module 32 may determine the noise threshold(s), in step 124, using one or more methods that are known in the art. For example, each noise threshold may be set as a centroid value for the respective sensor measurements in the identified noise measurement cluster, or as a boundary value, such as a minimum or maximum value of such sensor measurements. In particular, where the noise measurement cluster is identified by having a relatively low representative value compared to the other measurement clusters, the threshold value for each sensor may be determined as a maximum value of the respective sensor measurements in the noise measurement cluster, thereby ensuring that any sensor measurements below that value may be filtered as noise or unwanted measurements. Similarly, where the noise measurement cluster is identified by having a relatively high representative value compared to the other measurement clusters, the threshold values may be determined as respective minimum values of the noise measurement cluster, thereby ensuring that any sensor measurements above those value may be filtered as noise or unwanted measurements

Referring to the example shown in FIG. 6, the threshold value for the current sensor of the sensor module 22 may therefore be set based on the maximum current value in Cluster group 1. Consequently, any sensor measurements below that current value may be identified as noise or unwanted measurements.

In step 126, the sensor apparatus 20 is configured to perform one or more feedback actions based on the determined noise threshold(s).

For example, the feedback module 28 may be configured to apply the determined noise threshold(s) to the database of sensor measurements to filter the noise measurements accordingly, and/or to filter subsequent sensor measurements prior to addition to the database, thereby removing noise and reducing the computational burden required for event detection and further analysis of the power supply. In this manner, data points above the newly defined threshold can be identified as events while all data below this threshold can be considered as noise. Hence, it is envisaged that the sensor apparatus 20 will significantly reduce the need for costly on-board storage.

Additionally, or alternatively, the feedback module 28 may be configured to generate a notification to a user, or a connected electrical device or server, in dependence on the noise threshold. For example, such alerts may be communicated via the communications module 30. Furthermore, the feedback module 28 may be configured to selectively operate the circuit breaker mechanism 24 to interrupt the power supply to the electrical loads 2a-c.

For example, the sensor apparatus 20 may advantageously be configured to redetermine the noise threshold according to the method 100 described above, periodically or, for example, upon activation of one or more of the sensors of the sensor module 22. In this manner, changes in the determined noise threshold may be detected, where such changes may be indicative of a fault in one or more of the electrical loads 2a-c. The feedback module 28 can therefore be operated accordingly to warn users and/or to interrupt the power supply.

The sensor apparatus 20 can therefore leverage these insights and prevent hazards by interrupting the power supply to the electrical loads under risk.

It is noted that the steps of the method 100 are only provided as a non-limiting example of the disclosure though and many modifications may be made to the above-described examples without departing from the scope of the appended claims.

For example, other embodiments of the presently disclosed subject matter within the scope of the appended claims, may include further analysing the frequency characteristics of the power supply in the acquired sensor measurements for event detection purposes.

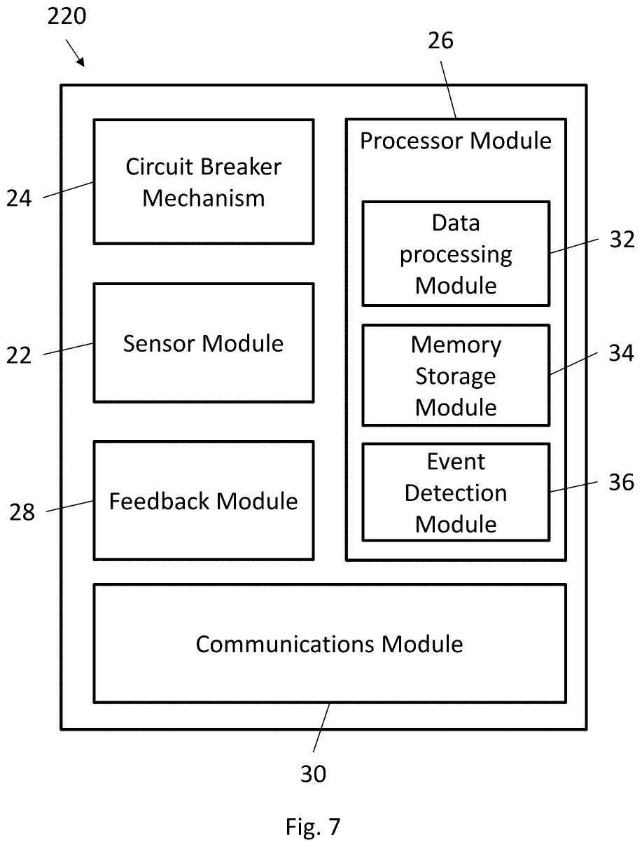

For this purpose, a further sensor apparatus 220 shall now be considered in more detail with reference to FIG. 7. The sensor apparatus 220 is substantially identical to the sensor apparatus 20, described in the previous example, and includes a sensor module 22, a circuit breaker mechanism 24, a processor module 26, a feedback module 28 and a communications module 30, as in the previous example.

However, the sensor apparatus 220 differs from the sensor apparatus 20, of the previous example, in that the processor module 26 is further configured to analyse the frequency characteristics of the power supply in the acquired sensor measurements for event detection purposes.

For this purpose, the processor module 26 may further include an event detection module 36, as shown in FIG. 7. The event detection module 36 is configured to analyse the frequency characteristics by determining the power spectral density (PSD) of the power supply, as captured in the acquired sensor measurements. The PSD is a measure of the power content of the power supply versus frequency. The PSD may therefore be determined based on an electric power signal formed by a series of the acquired sensor measurements. For example, a series of sensor measurement may be acquired by the sensor module 22 during an event, forming an electrical power signal indicative of the power supply during the event, and the event detection module 36 may be configured to determine the PSD of the electrical power signal to analyse the frequency characteristics of the power supply. For example, the data points (or sensor measurements) in the database of sensor measurements may be ordered, shaped and/or formatted to readily construct one or more electrical power signals from respective series of sensor measurements. Accordingly, the processor module 26 may be configured to compile a series of sensor measurements into an electrical power signal indicative of the power supply to the electrical loads 2a-c during a respective event. The series of sensor measurements may be stored accordingly as an electrical power signal in the database of sensor measurements, which may be used to analyse the power-frequency spectrum of the power supply during respective events, as shall be described in more detail.

It shall be appreciated that the frequency characteristics associated with the operation of an electrical device are largely specific to the particular operation being performed by that appliance. Hence, the PSD generated by a particular electrical device operation will be largely repeatable, and therefore recognisable. For example, the operation of a heating element is known to introduce white noise into the PSD. A motor on the other hand has a complex impedance but notably, small arcs of current may exist between electrical contacts, which is known to add pink noise to the PSD.

For this purpose, the event detection module 36 may include one or more spectrum analyser algorithms that are known in the art for determining the PSD of an electrical power signal.

In order to detect an event, i.e. a change in the operation of one or more of the electrical loads 2a-c, the event detection module 36 may be further configured to identify changes in the PSD. For example, the determined PSD may be compared to a reference PSD associated with a previous event, a baseline condition (where there is no power draw from the electrical loads 2a-c), and/or an average condition of the electrical loads 2a-c, in order to identify one or more changes in the determined PSD. The reference PSD may be stored in the memory storage module 34, for example. In order to compare the features of the determined PSD and the reference PSD, the event detection module 36 may include one or more data processing operations or algorithms that are known in the art. For example, the event detection module 36 may be configured to determine respective curve functions for the determined PSD and the reference PSD. For this purpose, the event detection module 36 may include one or more curve fitting functions that model different frequency ranges of a PSD with respective curve functions. For example, the one or more curve fitting functions may be configured to determine an average power curve, or a floor curve, for the determined PSD and the reference PSD for comparison to one another.

By way of example, for a baseline condition (in the absence of a power draw from the electrical loads 2a-c) a curve function for the PSD will have a characteristic 1/f line at low frequencies that flattens out at higher frequencies. However, when a heating element is operated, white noise is added to the determined PSD, producing a linear shift of the curve function. Accordingly, various features of the curve function for the determined PSD may be indicative of changes in the operations of the electrical loads 2a-c relative to the reference condition. Such features may include the slope and intersection point (i.e. the 1/f corner) of the curve function, amongst other features (such as duration of baselining, or a beta value for the function 1/(f\hat{ }β), for example where the beta value is 0 for white noise, 1 for pink noise, and 2 for Brownian noise).

In order to infer information associated with the operation of the electrical loads 2a-c, the event detection module 36 may be configured to determine the transformation operations between the respective curve functions of the reference PSD and the determined PSD, i.e. to determine how the curve function of the reference PSD is changed or what transformation operations are required to produce the curve function of the determined PSD.

The event detection module 36 may further include one or more schemes, rules, or methods, for classifying the operations of the electrical loads 2a-c based on the determined transformation operation(s). For example, as noted above, the operation of a heating element may produce a linear shift of the curve functions between the reference PSD and the determined PSD, and, upon determining the linear shift, the event detection module 36 may be configured to classify the event accordingly. In other examples, the event detection module 36 may be configured to classify events with reference to a database of classified events and associated transformation operations (relative to the reference PSD), or a look-up table, that may be stored in the memory storage module 34. Updates to the database may then be provided from one or more external servers via the communications module 30 of the circuit breaker 20, where offline analysis of the frequency characteristics can be carried out on the external servers.

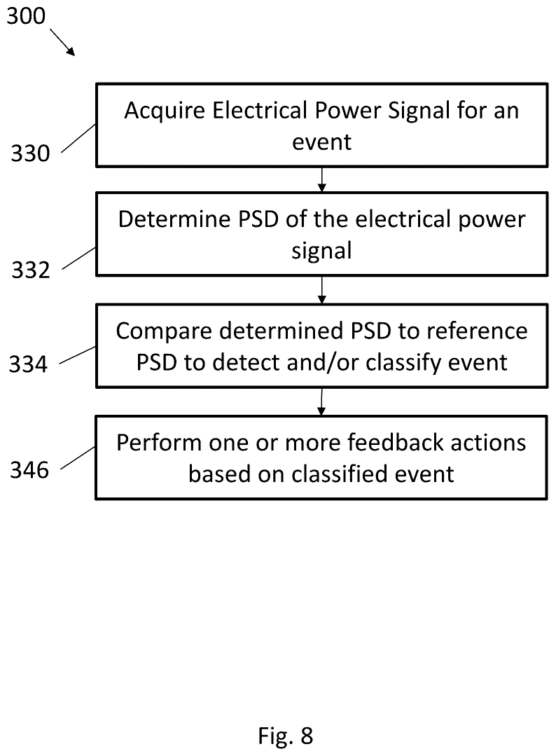

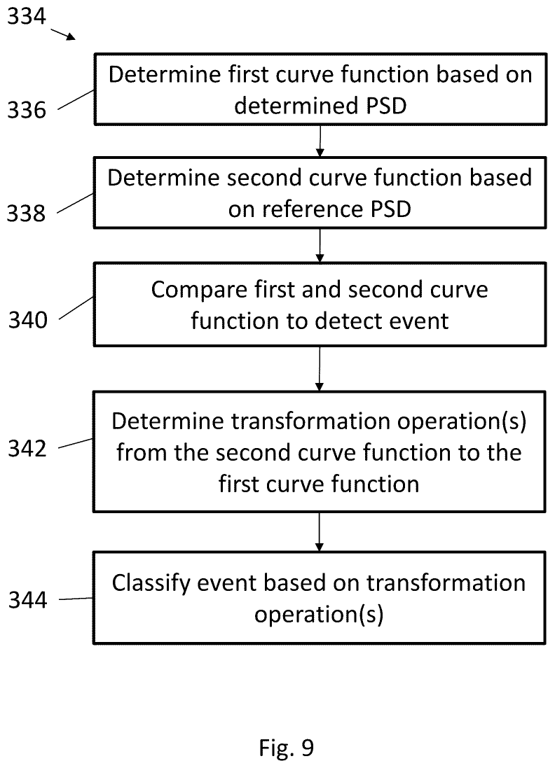

A method 300 of operating the sensor apparatus 220, shall now be described with additional reference to FIGS. 8 and 9.

As shown in FIG. 8, in step 330, the event detection module 36 may acquire an electrical power signal composed of a series of sensor measurements determined by the sensor module 22 during a respective event.

For example, the series of sensor measurement may be retrieved from the database of sensor measurements in the memory storage module 34 or otherwise determined by the sensor module 22. The acquired electrical power signal may therefore be based on a series of sensor measurements acquired by the current and voltage sensors, for example.

Advantageously, the circuit breaker 220 may therefore have filtered the series of sensor measurements using the noise threshold determined according to the steps 102 to 126 of the method 100 to remove extraneous sensor measurements. In this manner, the data processing can be carried out on a reduced set of useful data, such that sophisticated analysis can be carried out on-board the sensor apparatus 220.

In step 332, the event detection module 36 is configured to determine the PSD of the acquired electrical power signal. For this purpose, the event detection module 36 may use one or more of the spectrum analyser algorithms.

In step 334, the event detection module 36 is configured to compare the determined PSD to a reference PSD for the electrical circuit 3 in order to detect and/or classify the operations of the electrical loads 2a-c during the event.

For example, the reference PSD may be associated with a previous event, an average condition of the electrical circuit 3, or a baseline condition of the electrical circuit 3, during which there is no power draw from the electrical loads 2a-c. The determined PSD is compared to the reference PSD to identify changes that are indicative of respective operations, or states, of the electrical loads 2a-c. For example, the activation or deactivation of one of the electrical loads 2a-c will generate an identifiable shift in the determined PSD.

Accordingly, the event detection module 36 may apply one or more data processing operations or algorithms to compare the features of the determined PSD and the reference PSD, and thereby identify the differences that are indicative of the operations of the electrical loads 2a-c.

By way of example, FIG. 9 illustrates example sub-steps 336 to 342 of the method 300 that may be executed by the event detection module 36 to compare the determined PSD to the reference PSD and classify the operations of the electrical loads 2a-c during the event.

In sub-step 336, the event detection module 36 may determine a first curve function representing the power distribution in the determined PSD. For example, the event detection module 36 may use one or more curve fitting functions to determine the first curve function, which may, for example, represent an average power curve or a floor of the determined PSD.

In sub-step 338, the event detection module 36 is configured to determine a second curve function representing the power distribution in the reference PSD. For example, the event detection module 36 may be configured to recall the second curve function from the memory storage module 34 of the circuit breaker 220, or otherwise use one or more curve fitting functions to determine the second curve function based on the reference PSD. It shall be appreciated that for effective comparison to the first curve function, the second curve function may similarly represent an average power curve or a floor of the reference PSD respectively. Moreover, each of the first and second curve functions may therefore include a 1/f\hat{ }β curve function for a low frequency portion of the respective PSD and a further curve function for the broadband noise at a higher frequency portion of the respective PSD.

In sub-step 340, the event detection module 36 compares the first curve function to the second curved function to detect the event. For example, the event, i.e. a change in the operation of one or more of the electrical loads 2a-c, may be detected by a deviation of the first curve function from the second curve function.

In sub-step 342, in order to classify the detected event, the event detection module 36 may be further configured to determine one or more transformation operations between the first and second curve functions, where each transformation operation may be indicative of a change in the operation of the electrical loads 2a-c.

For example, the event detection module 36 may use one or more methods that are known in the art for determining transformation operations from one curve function to another and may, for example, compare respective slopes and/or intersection points of the first and second curve functions to determine such transformations.

In sub-step 344, the event detection module 36 may be configured to classify the event based on the determined transformation(s). For example, the event detection module 36 may include one or more schemes, rules, or algorithms, that associate a determined transformation with a respective operation of the electrical loads 2a-c. For example, such rules, schemes, or algorithms, may be programmed into the event detection module 36, and/or stored in the memory storage module 34, such that the event detection module 36 is able to associate a linear shift of the intersection point with the introduction of white noise, for example due to a heating element being operated. Similarly, a change of the slope may be associated with the introduction of pink noise, for example where small arcs of current are being generated between electrical contacts of a motor. Such arcing is unwanted and so the safety of the electrical circuit 3 may be improved by communicating this feature to a user. In this manner, the event detection module 36 is able to classify the operations of the electrical loads 2a-c during the event by analysing the shift in the PSD of the electrical power signal relative to the reference PSD.

Returning to FIG. 8, the method 300 may further include a step 346 of providing one or more feedback actions based on the detected or classified event. The one or more feedback actions may be determined by the feedback module 28, and may include transmitting, via a communications module, a warning signal to the one or more electrical loads 2a-c, and/or to an external server; and/or selectively operating the circuit breaker mechanism 24 to interrupt the power supply to the one or more electrical loads 2a-c.

As a result of the method 300, it is envisaged that the frequency characteristics of the power supply may be analysed to detect degradation in performance and even imminent failure of the electrical loads 2a-c. The circuit breaker 200 can leverage these insights and prevent hazards by interrupting the power supply to the electrical load under risk.

It will be appreciated that various changes and modifications can be made to the present disclosure without departing from the scope of the present application.

For example, the circuit breaker 20 may be connected to the power line 3 as part of a panel board, as described in the examples above, or as part of any other electricity distribution apparatus, or even as a standalone component.

1. A method of controlling a sensor apparatus for an electrical circuit, the electrical circuit comprising one or more electrical loads and a power line providing a supply of electrical power to the one or more electrical loads, the sensor apparatus comprising a sensor configured to monitor the power line, the method comprising:
applying a clustering algorithm to a database of sensor measurements acquired from the sensor, the database of sensor measurements comprising sensor measurements indicative of the power supply during one or more events associated with the operation of one or more of the electrical loads and sensor measurements indicative of noise measurements during a baseline condition of the electrical circuit, the clustering algorithm being applied to the database of sensor measurements to determine a set of measurement clusters;
identifying a cluster, from the set of measurement clusters, indicative of noise measurements;
determining a noise threshold for the sensor based on the cluster indicative of noise measurements; and
controlling one or more feedback actions of the sensor apparatus in dependence on the determined noise threshold.

2. A method according to claim 1, wherein identifying the cluster indicative of noise measurements comprises:
determining a representative value for each measurement cluster; and
identifying the cluster indicative of noise measurements based on a comparison of the representative values.

3. A method according to claim 2, wherein each representative value is determined as a centroid value for the respective measurement cluster or a boundary value for the respective measurement cluster.

4. A method according to claim 2, wherein the representative value associated with the cluster indicative of noise measurements is less than, or greater than, the representative values associated with the other measurement clusters.

5. A method according to claim 1, wherein the clustering algorithm is configured to determine the set of measurement clusters by:
partitioning the database of sensor measurements into a plurality of sets of measurement clusters, each set having a different number of measurements clusters; and
determining a natural number of measurement clusters for the database of sensor measurements.

6. (canceled)

7. (canceled)

8. A method according to claim 1, wherein the clustering algorithm is configured to validate the determined set of measurement clusters by:
determining a silhouette value for the set of measurement clusters;
comparing the determined silhouette value to a threshold value; and redetermining the set of measurement clusters using different partitioning parameters if the silhouette value is less than the threshold value.

9. (canceled)

10. (canceled)

11. A method according to claim 1, further comprising:
acquiring one or more further sensor measurements from the sensor; and
updating the database of sensor measurements to include the one or more further sensor measurements.

12. (canceled)

13. A method according to claim 1, wherein the one or more feedback actions include:
transmitting, via a communications module of the sensor apparatus, a warning signal to the one or more electrical loads and/or to an external server in dependence on the determined noise threshold;
filtering noise measurements from the database of sensor measurements by applying the noise threshold; and/or
selectively interrupting, via a circuit breaker mechanism of the sensor apparatus, the power supply to the one or more electrical loads.

14. A method according to claim 1, wherein the sensor apparatus includes N sensors for monitoring the power line, where N is a positive integer, and wherein the database of sensor measurements is a database of N-dimensional data points, each data point comprising sensor measurements acquired from the N sensors at a respective time; and wherein a respective noise threshold is determined for each of the N sensors based on the respective sensor measurements acquired from that sensor in the cluster indicative of noise measurements.

15. (canceled)

16. A method according to claim 1, further comprising detecting an event associated with the operation of one or more of the electrical loads by:
acquiring an electrical power signal composed of a series of sensor measurements obtained by the sensor during the event;
determining a power spectral density of the electrical power signal; and
detecting the event by comparing the determined power spectral density to a reference power spectral density for the power line.

17. A method according to claim 16, wherein the reference power spectral density for the power line is associated with at least one of:
a previous event;
a baseline condition of the power line, with substantially no power being drawn by the one or more electrical loads; and/or
an average condition of the power line.

18. A method according to claim 16, wherein the event is detected by:
determining a first curve function representing the power spectral density of the electrical power signal;
determining a second curve function representing the reference power spectral density; and
detecting the event based on a deviation of the first curve function from the second curve function.

19. A method according to claim 18, further comprising:
determining one or more transformation operations from the second curve function to the first curve function; and
classifying the event based on the determined one or more transformation operations.

20. A method according to claim 16, further comprising controlling one or more feedback actions of the sensor apparatus in dependence on the event classification, the one or more feedback actions including:
transmitting, via a communications module of the sensor apparatus, a warning signal to the one or more electrical loads and/or to an external server; and/or
selectively interrupting, via a circuit breaker mechanism of the sensor apparatus, the power supply to the one or more electrical loads.

21. (canceled)

22. (canceled)

23. (canceled)

24. A sensor apparatus for an electrical circuit, the electrical circuit comprising one or more electrical loads and a power line providing a supply of electrical power to the one or more electrical loads, the sensor apparatus comprising:
a sensor configured to monitor the power line; and
a control module configured to execute the method of claim 1;
wherein the sensor is configured to acquire the database of sensor measurements.

25. A sensor apparatus according to claim 24, wherein the sensor apparatus further comprises a circuit breaker mechanism, and wherein the one or more feedback actions of the sensor apparatus comprise controlling the circuit breaker mechanism to selectively interrupt the power supply to the one or more electrical loads.

26. A method of controlling a sensor apparatus for an electrical circuit, the electrical circuit comprising one or more electrical loads and a power line providing a supply of electrical power to the one or more electrical loads, the sensor apparatus comprising a sensor configured to monitor the power line, the method comprising:
acquiring an electrical power signal composed of a series of sensor measurements obtained by the sensor for a respective event;
determining a power spectral density of the electrical power signal;
detecting the event by comparing the determined power spectral density to a reference power spectral density for the power line, the comparison comprising:
determining a first curve function representing the power spectral density of the electrical power signal;
determining a second curve function representing the reference power spectral density; and
detecting the event based on a deviation of the first curve function from the second curve function.

27. A method according to claim 26, wherein the reference power spectral density for the power line is associated with at least one of:
a previous event;
a baseline condition of the power line, with substantially no power being drawn by the one or more electrical loads; and/or
an average condition of the power line.

28. A method according to claim 26, further comprising:
determining one or more transformation operations from the second curve function to the first curve function; and
classifying the event based on the determined one or more transformation operations.

29. A method according to claim 28, further comprising controlling one or more feedback actions of the sensor apparatus in dependence on the detected event, the one or more feedback actions including:
transmitting, via a communications module of the sensor apparatus, a warning signal to the one or more electrical loads and/or to an external server in dependence on the detected event; and/or
selectively interrupting, via a circuit breaker mechanism of the sensor apparatus, the power supply to the one or more electrical loads.
